(19) United States
(12) Patent Application Publication
(10) Pub. No.: US 2015/0064523 A1
(43) Pub. Date: Mar. 5, 2015

(54) BATTERY MODULE

(71) Applicant: Samsung SDI Co., Ltd., Yongin-si (KR)

(72) Inventor: Young-Bin Lim, Yongin-si (KR)

(21) Appl. No.: 14/472,211

(22) Filed: Aug. 28, 2014

(30) Foreign Application Priority Data
Aug. 30, 2013 (KR) 10-2013-0103762

(51) Int. Cl. H01M 2/10; H01M 10/625; H01M 10/656

(52) U.S. Cl. CPC H01M 2/1077; H01M 10/5061; H01M 10/5016; H01M 2220/20
USPC 429/82; 429/156

(57) ABSTRACT

A battery module includes a plurality of battery cells, at least one barrier between respective adjacent battery cells of the plurality of battery cells, and a housing. The plurality of battery cells are aligned along a first direction. At least one barrier is between respective adjacent battery cells of the plurality of battery cells. The housing accommodates the plurality of battery cells and the barriers therein. In the battery module, each barrier between respective adjacent battery cells includes a base parallel to a wide surface of the respective adjacent battery cells, at least one spacer protruding in a direction parallel to the first direction and extending toward the wide surface of a respective adjacent battery cell from the base, and at least one support extending further from the base than the at least one spacer.

### CROSS-REFERENCE TO RELATED APPLICATION

This application claims priority to and the benefit of Korean Patent Application No. 10-2013-0103762, filed on Aug. 30, 2013, in the Korean Intellectual Property Office, the entire contents of which are incorporated herein by reference in their entirety.

### BACKGROUND

1. Field

An aspect of the present invention relates to a battery module, and more particularly, to a battery module in which battery cells can be firmly fixed within the module.

2. Description of the Related Art

A high-power battery module using a non-aqueous electrolyte with high energy density has recently been developed. This high-power battery module is a large-capacity battery module manufactured by connecting a plurality of battery cells in series for use in driving motors of devices requiring high power, for example, electric vehicles, etc. Further, a battery pack can be manufactured by electrically connecting a plurality of these high-power battery modules together.

A battery cell generates an electrochemical reaction generating electrical energy that is transferred to the outside of the battery cell through negative and positive electrode terminals. In this type of battery cell, a case housing the battery cell is generally made of metal, and, hence, risks the occurrence of an electrical short circuit between the case and the battery cell. Thus, these battery cells are often insulated from the case. Additionally, in battery modules connecting a plurality of battery cells, an assembling tolerance between the battery cells in the process of connecting the battery cells together may occur, allowing movement of the battery cells. This assembling tolerance may cause safety concerns when the battery cells are moved.

### SUMMARY

Embodiments of the present invention relate to a battery module, and more particularly, to a battery module in which battery cells can be firmly fixed against movement within the module.

Embodiments of the present invention provide a battery module in which the battery cells of a plurality of battery cells are each firmly fixed by offsetting a tolerance gap caused by the size of the battery cells within a housing.

Embodiments of the present invention also provide a battery module in which battery cells are fixed against movement by externals force such as vibrations or impact.

According to an aspect of the present invention, there is provided a battery module, including, a plurality of battery cells aligned along a first direction; at least one barrier between respective adjacent battery cells of the plurality of battery cells; and a housing accommodating the plurality of battery cells and the barriers therein, wherein each barrier between respective adjacent battery cells includes a base parallel to a wide surface of the respective adjacent battery cells, at least one spacer protruding in a direction parallel to the first direction and extending toward the wide surface of a respective adjacent battery cell from the base, and at least one support extending further from the base than the at least one spacer.

Each battery cell of the plurality of battery cells may include a battery case accommodating an electrode assembly. The wide surface of each battery cell may include a face configured to face the electrode assembly, and an edge extending from a perimeter of the face toward sides of the wide surface of the battery cell.

The edge may surround the wide surface of the battery cell, the face may be surrounded by the edge, the at least one spacer may contact the face, and the at least one support may be configured to compress the edge.

The base may include a shape corresponding to the wide surface of the battery cells.

The at least one spacer may be at an inside of the base, and the at least one support may be adjacent to an end portion of the base.

The barrier may further include one or more flanges facing side surfaces of the respective adjacent battery cell from at least one side of each edge of the base.

The one or more flanges may include a pair of side flanges at each respective side portion of the base, a lower flange at a lower portion of the base, and an upper flange at an upper portion of the base.

The side and/or lower flanges may define one or more openings configured to act as a passageway for a heat exchange medium.

The pair of side flanges may face each other in a second direction perpendicular to the first direction, and the at least one support may protrude in the first direction and extend in the second direction.

Each of the side flanges may define a plurality of openings spaced apart from each other, and a bridge between adjacent openings of the plurality of openings. The openings provided in each of the side flanges may face each other, and the at least one support may be configured to correspond to the bridge.

The openings in each of the side flanges may be configured to provide a passageway for a heat exchange medium, and the at least one support may be parallel to a direction of flow of the heat exchange medium.

The at least one support may include one or more first support tabs adjacent to an upper end portion of the base parallel to the upper end portion, and one or more second support tabs adjacent to a lower end portion of the base parallel to the lower end portion. The first and second support tabs may be configured to correspond with each other.

The at least one support may further include third support tabs adjacent to each respective end portion of the base in a direction perpendicular with to each respective end portion.

The supports of the first support tab and the supports of the second support tab may each include respective first surfaces extending in the first direction and facing each other. The first surfaces may be parallel to each other.

The supports of the first support tab and the supports of the second support tab may each include respective second surfaces opposite to the first surfaces. The second surfaces may be inclined toward the first direction.

An end of the at least one support may be divided into a first portion and a second portion through its center. The first and second portions may be configured to contact the respective adjacent battery cell and to face each other while extending in opposite directions.

The at least one support may be coupled to the base with a rounded form.

An end of the at least one support contacting the battery cell may be rounded.

A height of the at least one support may be approximately 0.4 millimeters to 2 millimeters greater than a height of the at least one spacer.

### BRIEF DESCRIPTION OF THE DRAWINGS

Example embodiments will now be described more fully with reference to the accompanying drawings; however, aspects of the present invention may be embodied in different forms and should not be construed as limited to the embodiments set forth herein. Rather, these embodiments are provided for thoroughness and completeness of this disclosure, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of a battery module according to an embodiment of the present invention.

FIG. 2 is a perspective view showing battery cells and a barrier in a battery module according to an embodiment of the present invention.

FIG. 3 is a front elevation view of the barrier shown in the embodiment of FIG. 2.

FIG. 4 is a front elevation view of the barrier of FIG. 2 with a barrier cell located at one side thereof.

FIG. 5 is a cross-sectional view of the barrier shown in FIG. 4 taken along line I-I of FIG. 4.

FIG. 6 is a schematic view of a barrier according to an embodiment of the present invention interposed between adjacent battery cells.

FIG. 7 is an enlarged perspective view of a support according to an embodiment of the present invention.

FIG. 8 is a perspective view showing battery cells and a barrier in a battery module according to another embodiment of the present invention.

FIG. 9 is a cross-sectional view of the barrier shown in FIG. 8 taken along line II-II of FIG. 8.

FIG. 10 is a schematic view showing the barrier of FIG. 8 interposed between the battery cells shown in FIG. 8.

FIG. 11 is an enlarged perspective view of a support according to another embodiment of the present invention.

FIG. 12 is a perspective view showing an end of the support of FIG. 11.

FIG. 13 is a schematic view showing a barrier having the support of FIG. 11 interposed between battery cells.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed between. Also, when an element is referred to as being “connected to” another element, it can be directly connected to the another element or be indirectly connected to the another element with one or more intervening elements interposed between. Hereinafter, like reference numerals refer to like elements.

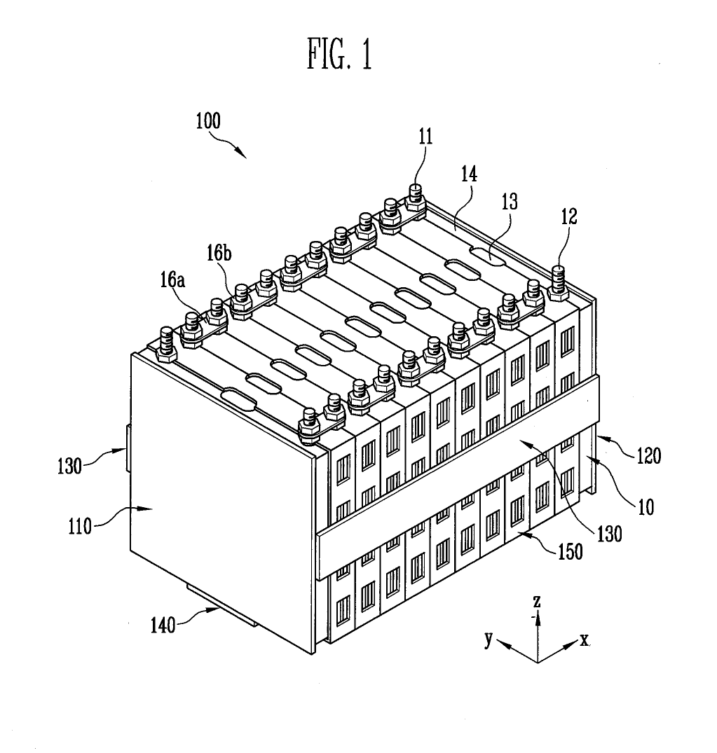

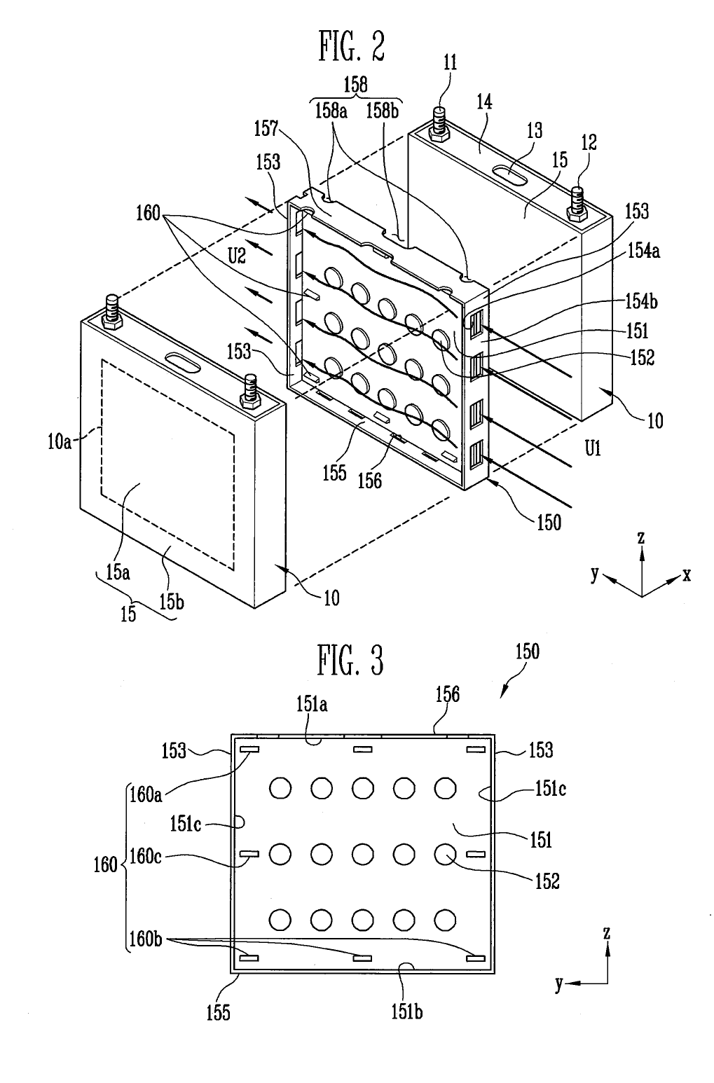

FIG. 1 is a perspective view of a battery module according to an embodiment of the present invention. FIG. 2 is a perspective view showing battery cells and a barrier in a battery module according to an embodiment of the present invention.

The battery module 100 according to the embodiment shown in FIGS. 1 and 2 includes a plurality of battery cells 10 aligned along a first direction (x-direction) with barriers 150 interposed between respective battery cells 10 of the plurality of battery cells 10, and a housing 110, 120, 130, and 140 configured to accommodate the plurality of battery cells 10 and the barriers 150 interposed between. Each barrier 150 includes a base 151 parallel to a wide surface 15 of the battery cells 10 (in a direction perpendicular to the first or x-direction), at least one spacer 152 protruding from a surface of the base 151 in a direction parallel to the first or x-direction toward the respective battery cell 10 adjacent to the base 151, and at least one support 160 extending out from the base 151 a distance greater than the length of each spacer 152.

The plurality of battery cells 10 are aligned in the first direction (x-direction), with adjacent battery cells 10 lined up such that the wide surfaces 15 of respective adjacent battery cells 10 face each other. Each battery cell 10 may include an electrode assembly 10a and an electrolyte positioned inside a battery case through an open surface of the case, the open surface then being hermetically sealed with a cap assembly 14. The cap assembly 14 may include a positive electrode terminal 11, a negative electrode terminal 12, and a vent 13. The electrode assembly 10a in this embodiment is electrically connected to the positive and negative electrode terminals 11 and 12, and the positive and negative electrode terminals 11 and 12 become a path through which energy generated by an electrochemical reaction between the electrode assembly 10a and the electrolyte may be transferred. In addition, the vent 13 acts as a passage through which gas generated inside the battery cell 10 is exhausted to an outside of the battery cell 10.

In an embodiment, the electrode assembly 10a may include a positive electrode plate having a lithium compound coated thereon, a negative electrode plate having carbon coated thereon, and a separator interposed between the positive and negative electrode plates. The electrode assembly 10a in this embodiment may a stacked or wound assembly of the positive electrode plate, the negative electrode plate, and the separator. In addition, in this embodiment, each of the positive and negative electrode plates include electrode tabs to be electrically connected to the positive and negative electrode terminals 11 and 12, respectively. The electrode assembly 10a inside the battery case, as described, may not entirely fill an inside of the battery case and may be spaced apart a predetermined interval from the inside of the battery case at both side surfaces, an upper surface, and a lower surface, which constitute end portions of the battery case. Thus, only a portion of the wide surface 15 of each battery cell 10 contacts or faces the electrode assembly 10a. In these embodiments, the wide surface 15 of the battery cell 10 may include a face 15a facing the electrode assembly 10a, and an edge 15b extending from an outer perimeter of the face 15a to corners of the wide surface 15 of the battery cell 10. In this embodiment, the electrode assembly 10a occupies a portion of the wide surface 15 of the battery cell 10 at the face 15a corresponding to the dotted line shown in FIG. 2.

The housing 110, 120, 130, and 140 couples the plurality of battery cells 10 and the barriers 150 respectively interposed between the battery cells 10 together such that the plurality of battery cells 10 may act as one power source. The housing 110, 120, 130, and 140 may include a pair of first and second end plates 110 and 120 disposed to face the wide surfaces 15 of the outermost battery cells 10, respectively, and connecting members 130 and 140 connecting the first and second end plates 110 and 120.

The connecting members 130 and 140 may include a pair of side plates 130 and a bottom plate 140. The pair of side plates 130 may respectively support each side surface of the battery cells 10, and the bottom plate 140 may support a bottom surface of the battery cells 10. One end of the side plate 130 and one end of the bottom plate 140 are fastened to the first end plate 110, and the other end of the side plate 130 and the other end of the bottom plate 140 are fastened to the second end plate 120, thereby connecting the first and second end plates 110 and 120. In this embodiment, the plates may be fastened by any type of connection, for example, a bolt-nut connection, etc., but the present invention is not limited thereto.

The first and second end plates 110 and 120 and the connecting members 130 and 140 couple the plurality of battery cells 10 together, and a bus-bar 16a may electrically connect the positive or negative electrode terminals 11 or 12 of two adjacent battery cells 10 to each other. The bus-bar 16a may have holes through which each of the positive and negative electrode terminals 11 and 12 can extend. In this embodiment, the bus-bar 16a connects the positive and negative electrode terminals 11 and 12 that extend through the respective holes in the bus-bar 16a, and the connection may be fixed by any type of connector, i.e., a nut 16b, etc.

The first and second end plates 110 and 120, the pair of side plates 130, and the bottom plate 140 are used to stably connect the plurality of battery cells 10 and the barriers 150 together. However, the present invention is not limited thereto, and may be modified and embodied differently. The connection structure of the battery cells 10 and the number of the battery cells 10 may vary according to the design of the battery module 100.

The barrier 150 in these embodiments is located between adjacent battery cells 10 to prevent the adjacent battery cells 10 from directly contacting each other. The barrier 150 may include a base 151 parallel to the wide surface 15 of the battery cell 10, and one or more flanges 153, 155, and 157 extending perpendicularly at edges of the base 151. The base 151 may have a shape corresponding to the wide surface 15 of the battery cell 10. The base 151 may include a plurality of spacers 152 protruding from a surface of the base 151 facing the respective adjacent battery cell 10 such that the base 151 and the battery cell 10 are spaced apart from each other. in this embodiment, the plurality of spacers 152 may be provided to be spaced apart from each other. In addition, the base 151 may be include one or more supports 160 protruding in the same direction as the spacers 152, the supports 160 being longer than the spacers 152. The spacers 152 may be located on an inside surface of the base 151, and the supports 160 may be located adjacent to end portions 151a, 151b, and 151c of the base 151.

The one or more flanges 153, 155, and 157 of the barriers 150 may face side surfaces of the respective adjacent battery cell 10 from at least one side of each corner of the base 151. The flanges 153, 155, and 157 may include a pair of side flanges 153 respectively located at both side portions of the base 151, a lower flange 155 located at a lower portion of the base 151, and an upper flange 157 located at an upper portion of the base 151. The side and/or lower flange 153 and/or 155 may have one or more openings 154a or 156 functioning as passages for a heat exchange medium, e.g., cooling air, cooling water, etc. The openings 154a or 156 may include a plurality of holes spaced apart from each other in a lengthwise direction of the side or lower flanges 153 or 155. The openings 154a or 156 may be located at a central portion of the side or lower flange 153 or 155. Since the openings 154a or 156 may be located at the central portion of the side or lower flange 153 or 155, the heat exchange medium can be supplied to front and rear surfaces of the base 151.

The battery module 100 includes the plurality of battery cells 10, each battery cell 10 generating heat while being repetitively recharged/discharged. The generated heat accelerates degradation of the battery cells 10, and may have serious consequences such fires or explosions of the battery cells 10. Therefore, the heat must be controlled. In this embodiment, the openings 154a and 156 in the side and lower flanges 153 and 155 of the barrier 150 may act as passages U1 through to U2 of the heat exchange medium. The heat exchange medium can flow in the barrier 150 through the openings 154a and 156 and directly face the wide surface 15 of the battery cell 10 by passing between the spacers 152 of the base 151. Thus, the heat exchange medium can be utilized to exchange heat with the battery cell 10. Accordingly, it may be possible to effectively control the temperature of the battery cells 10 and extend the lifespan of the battery module 100.

The upper flange 157 may have a shape corresponding to the cap assembly 14 of the battery cell 10. For example, the upper flange 157 may have one or more concave portions 158 through which the positive electrode terminal 11, the negative electrode terminal 12, and the vent 13 are exposed to the outside. The concave portions 158 may include a first concave portion 158a having a shape corresponding to approximately half of a section of the positive or negative electrode terminal 11 or 12, and a second concave portion 158b having a shape corresponding to approximately half of a section of the vent 13. The upper flanges 157 of adjacent barriers 150 interposed between the battery cells 10 are adjacent to each other, and the respective counterpart concave portions 158 may correspondingly line up. In these embodiments, the first concave portions 158a of the adjacent upper flanges 157, each having a shape corresponding to approximately half of a section of the positive or negative electrode terminal 11 or 12, may allow the positive or negative electrode terminal 11 or 12 to be exposed therethrough, and the second concave portions 158b of the adjacent upper flanges 157, each having a shape corresponding to approximately half of a section of the vent 13, may allow the vent 13 to be exposed therethrough.

In some embodiments, the side flange 153 include a pair of side flanges facing each other in a second direction (y-direction) vertical to the first direction (x-direction). The support 160 protrudes in the first direction (x-direction). In this case, the support 160 may extend along the second direction (y-direction). The pair of side flanges 153 may include a plurality of openings 154a spaced apart from each other, and a bridge 154b between adjacent openings 154a. The openings 154a in the pair of side flanges 153 face each other. The support 160 may correspond to the bridge 154b. The opening 154a may act as a passageway for the heat exchange medium. In embodiments where the support 160 is at a position corresponding to the opening 154a, the support 160 may interfere with the flow of the heat exchange medium and increase the differential pressure of the heat exchange medium. Therefore, in those embodiments, the support 160 may lower the heat exchange efficiency of the battery module 100. Accordingly, the support 160 in embodiments of the present invention extends along the second direction (y-direction) parallel to the flow direction of the heat exchange medium. In these embodiments, the support 160 corresponds to the bridge 154b while avoiding the openings 154a. Similarly, the support 160 adjacent to the lower flange 155 may also be at a position corresponding to the space between adjacent openings 156 and not facing the openings 156. Thus, the support 160 in these embodiments does not interfere with the flow of the heat exchange medium out through the openings 156 of the lower flange 155.

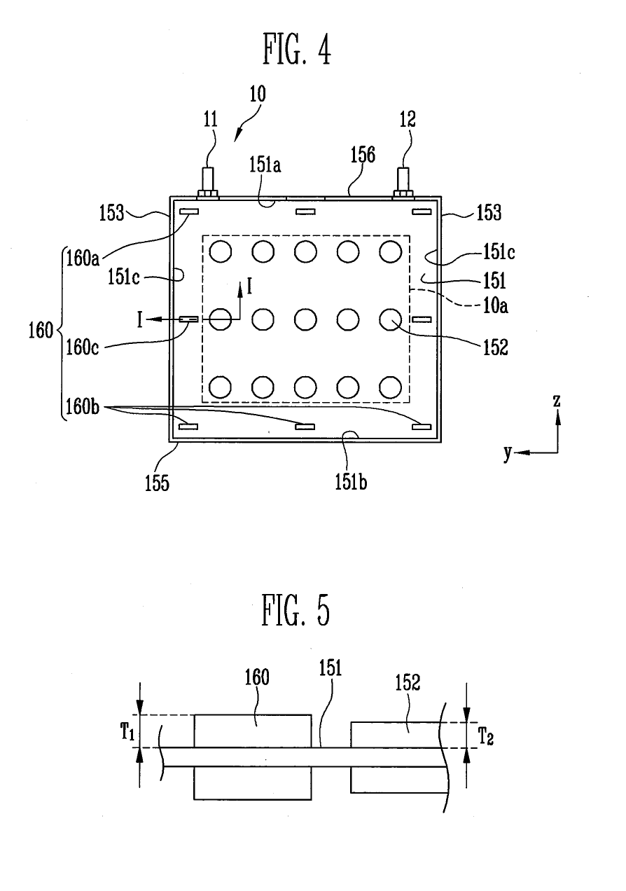

FIG. 3 is a front elevation view of the barrier shown in the embodiment of FIG. 2. FIG. 4 is a front elevation view of the barrier of FIG. 2 having a barrier cell located at one side thereof.

Referring to FIGS. 3 and 4, in an embodiment where the wide surface 15 of the battery cell 10 is divided into a face 15a facing the electrode assembly 10a and an edge 15b, the edge 15b may be located along the sides of the wide surface 15 of the battery cell 10, and the face 15a may be surrounded by the edge 15b. In this embodiment, the spacer 152 may contact the face 15a, and the support 160 may compress the edge 15b (see FIG. 2).

The support 160 may fix the battery cell 10 by compressing the edge 15b. (which does not face the electrode assembly 10a) at the wide surface 15 of the battery cell 10. Thus, although pressure is applied by the support 160, the pressure does not impact the electrode assembly 10a, and accordingly, the battery cell 10 may be stably used.

The support 160 includes one or more first support tabs 160a adjacent to an upper end portion 151a of the base 151 and parallel to the upper end portion 151a, and one or more second support tabs 160b adjacent to a lower end portion 151b of the base 151 and parallel to the lower end portion 151b. The first and second support tabs 160a and 160b may be at positions corresponding to each other. In an embodiment, the first and second support tabs 160a and 160b may be parallel to each other, and the supports 160 of the first support tab 160a and the supports 160 of the second support tab 160b may be equal in number at positions corresponding to each other. The support 160 may further include third support tabs 160c respectively adjacent to both side end portions 151 c of the base 151 and vertical with respect to both the side end portions 151c. The third support tab 160c may be between the first and second support tabs 160a and 160b. The first through third support tabs 160a, 160b, and 160c may be parallel to the flow of the heat exchange medium. The first through third support tabs 160a, 160b, and 160c may be located away from the openings 156 acting as passages for the heat exchange medium.

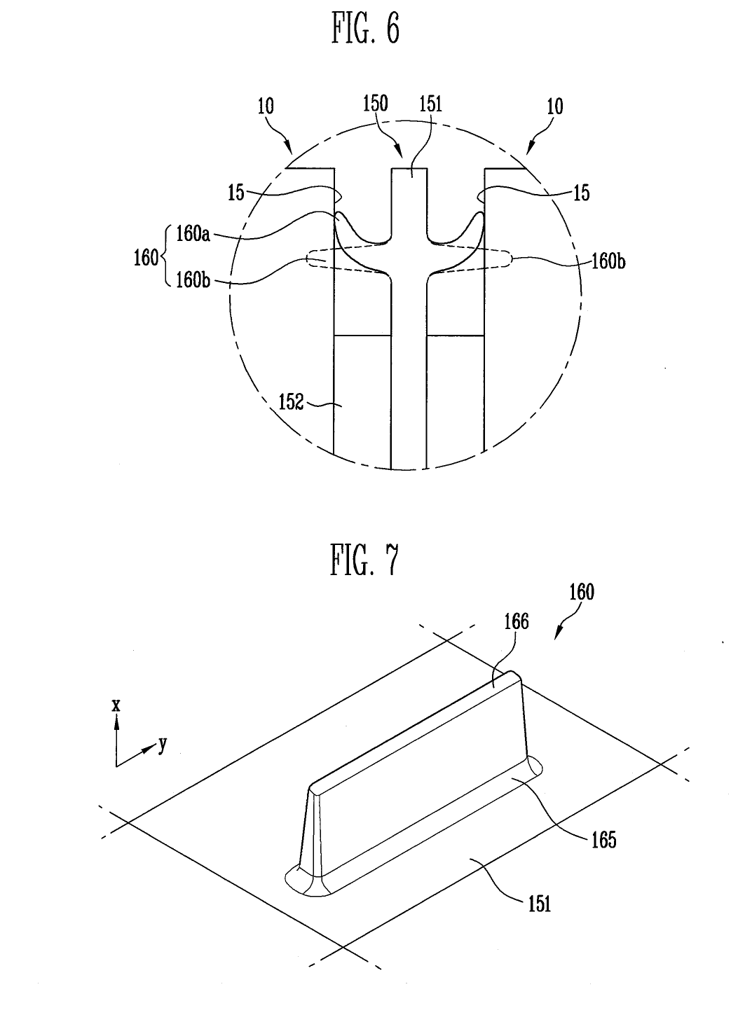

FIG. 5 is a cross-sectional view of the barrier shown in FIG. 4 taken along line I-I of FIG. 4. FIG. 6 is a schematic view showing the barrier of FIG. 4 interposed between adjacent battery cells. FIG. 7 is an enlarged perspective view of the support according to an embodiment of the present invention.

Referring to FIGS. 5 and 6, the support 160 may be longer than the spacers 152. For example, a height T1 of the support 160 may be greater by than a height T2 of the spacers 152 by approximately 0.4 millimeters (mm) to 2 mm. The spacers 152 of the barrier 150 allow adjacent battery cells 10 to be spaced apart from each other, the barrier 150 providing a path through which the heat exchange medium can flow between adjacent battery cells 10. In this embodiment, the positions of the adjacent battery cells 10 may be fixed by the spacers 152.

In other battery modules, where a plurality of battery cells 10 are aligned, an assembly tolerance gap may occur due to a difference in thickness between the battery cells or a difference in size between the barriers. In the embodiments of the present invention, the support 160 protrudes longer than the spacers 152 of the base 151, providing some flexibility, but with a rigid lower portion than that of the spacer 152. Thus, the support 160 can fix the battery cell 10 without an assembly tolerance gap even when the spacing between the spacer 152 and the battery cell 10 is greater than the length of the spacer 152. Accordingly, the support 160 can firmly fix the battery cell 10 such that the battery cell 10 is not moved by an external force such as vibration or impact. For example, the spacers 152 may contact or be spaced apart from the wide surface 15 of the battery cell 10 by an assembly tolerance gap. In this embodiment, the support 160 may be reversibly elastically bent the spacing distance between the support 160 and the battery cell 10 (from 160a to 160b, as shown in FIG. 6) to fix the battery cell 10. Thus, it is possible to remedy the assembly tolerance gap of the battery cell 10 and to efficiently perform a manufacturing process.

In battery modules where the difference between the height T1 of the support 160 and the height T2 of the spacer 152 is less than 0.4 mm, it may not suffice to offset the assembly tolerance gap caused by the thickness of the battery cell 10 or the size of the barrier 150. Therefore, in these instances, it may be difficult to sufficiently fix the battery cell 10 with the support 160. In battery modules where the difference between the height T1 of the support 160 and the height T2 of the spacer 152 exceeds 2 mm, a compression pressure of the battery cell 10 may undesirably increase by the support 160. Therefore, the difference between the height T1 of the support 160 and the height T2 of the spacer 152 is preferably between 0.4 mm to 2 mm.

Referring to FIG. 7, the support 160 protrudes from the base 151, and a width of the support 160 may gradually decrease as the support 160 approaches an end 166 thereof. The support 160 may be connected in a rounded form 165 to the base 151. When compressing the battery cell 10, the support 160 may receive pressure corresponding to the compression. In this embodiment, the support 160 is connected in the rounded form 165 to the base 151, and hence the pressure is equally distributed, thereby preventing the occurrence of a crack or similar flaw. The end 166 of the support 160, contacting the battery cell 10, may be rounded. The end 166 of the support 160 may experience friction during contact with the wide surface 15 of the battery cell 10. Therefore, the end 166 of the support 160 may wear away. In an example where the end 166 of the support 160 is angular, a scratch or other flaw may result on the wide surface 15 of the battery cell 10 when compressed by the support 160. However, in an embodiment where the end 166 of the support 160 is rounded, a decrease in the contact area of the support 160 with the battery cell 10 may result. Accordingly, abrasion or friction of the end 166 of the support 160 with the battery cell 10 may be reduced or prevented.

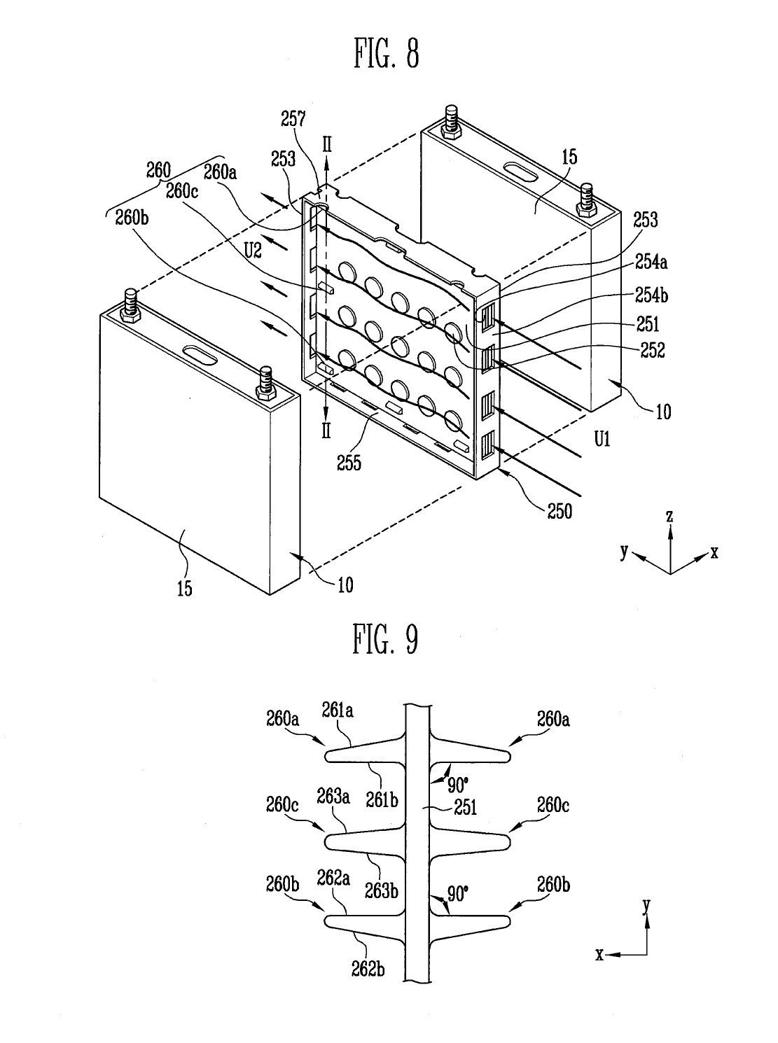

Hereinafter, other embodiments of the present invention will be described with reference to FIGS. 8 to 13. Contents of these embodiments, except the following, are similar to those of the embodiment described with reference to FIGS. 1 to and therefore, their detailed descriptions will be omitted.

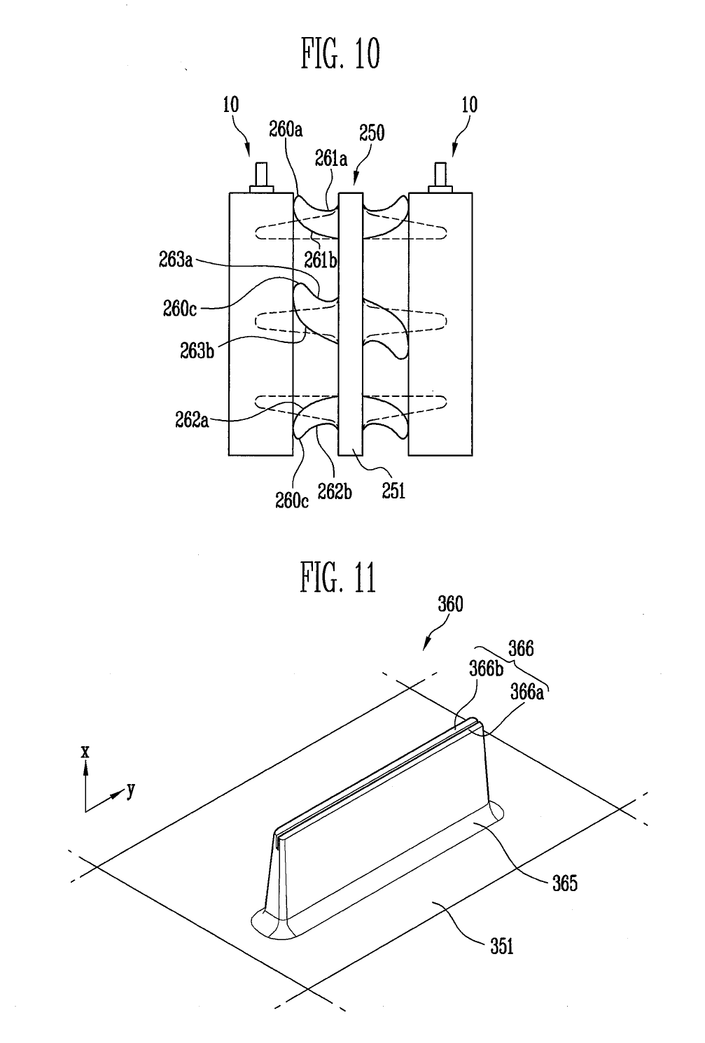

FIG. 8 is a perspective view showing battery cells and a barrier in a battery module according to another embodiment of the present invention. FIG. 9 is a cross-sectional view of the barrier shown in FIG. 8 taken along line II-II of FIG. 8. FIG. 10 is a schematic view showing the barrier of FIG. 8 interposed between the battery cells shown in FIG. 8.

Referring to FIGS. 8 through 10, a barrier 250 may be positioned between adjacent battery cells 10. The barrier 250 may include a base 251 corresponding to the wide surface 15 of each battery cell 10, one or more flanges 253, 255, and 257 positioned vertical to corners of the base 251, and at lease one spacer 252 and a support 260 protruding toward the battery cells 10 from the base 251. The spacers 252 and the support 260 may allow the battery cells 10 and the respective barrier 250 to be spaced apart from each other, thereby providing a flow path for a heat exchange medium. In this embodiment, the support 260 may protrude further than the spacer 252. The flanges 253, 255, and 257 may include a pair of side flanges 253 respectively positioned at both side portions of the base 251, a lower flange 255 positioned at a lower portion of the base 251, and an upper flange 257 positioned at an upper portion of the base 251. The side or lower flanges 253 or 255 may have one or more openings 254a acting as passages for the heat exchange medium, e.g., cooling air, cooling water, etc. The pair of side flanges 253 may also include a bridge 254b between adjacent openings 254a. The openings 254a in the pair of side flanges 253 may face each other. The support 260 may correspond with the bridge 254b.

The support 260 may include one or more first support tabs 260a adjacent to an upper end portion of the base 251 parallel to the upper end portion, one or more second support tabs 260b adjacent to a lower end portion of the base 251 parallel to the lower end portion, and third support tabs 260c adjacent to both respective end portions of the base 251 and perpendicular to both end portions. In this embodiment, the first and second support tabs 260a and 260b correspond to each other, and the third support tab 260c includes a pair of third support tabs 260c adjacent to both respective end portions of the base 251. In this embodiment, the pair of third support tabs 260c may correspond with each other between the first and second support tabs 260a and 260b.

The supports 260 of the first support tab 260a and the supports 260 of the second support tab 260b include first surfaces 261b and 262a, respectively, which extend in the first direction (x-direction) and face each other. The first surfaces 261b and 262a may be parallel to each other. In addition, the supports 260 of the first support tab 260a and the supports 260 of the second support tab 260b may include second surfaces 261a and 262b, respectively, opposite to the first surfaces 261b and 262a. The first surfaces 261b and 262a which face each other in the first and second support tabs 260a and 260b may extend approximately perpendicularly (or vertically with respect to the base 251). Thus, the first surfaces 261b and 262a may be parallel to each other. Conversely, the second surfaces 261a and 262b, which are opposite to the first surfaces 261b and 262a, may be inclined toward the first direction (x-direction). Thus, the supports 260 of the first and second support tabs 260a and 260b may have an approximately trapezoidal section toward the first direction (x-direction). In this embodiment, the supports 260 of the first and second support tabs 260a and 260b may be provided such that, in the first direction, the first surfaces 261b and 262a are parallel and the second surfaces 261a and 262b are inclined. The supports 260 of the third support tab 260c may be such that first and second surfaces 263a and 263b are inclined toward the first direction (x-direction) from the base 251. The supports 260 of the third support tab 260c may be such that an area of a section perpendicular to the first direction (x-direction) gradually decreases.

Thus, in an embodiment where the wide surface 15 of the battery cell 10 is compressed by the first and second support tabs 260a and 260b, the supports 260 of the first and second support tabs 260a and 260b may be bent by the shapes of the first surfaces 261b and 262a and the second surfaces 261a and 262b, such that it is possible to control the direction in which the ends of the supports 260 face. Accordingly, the ends of the supports 260 of the first support tab 260a may be bent upward such that the flat surfaces of the first surfaces 261b and 262a contact the battery cell 10, and the ends of the supports 260 of the second support tab 260b bend downward, away from the first support tab 260a. Since the third support tab 260c has no flat surface, the ends of the supports 260 of the third support tab 260c may bend upward or downward, in this embodiment. The barrier 250 according to this embodiment may control the direction in which the supports 260 are bent, thereby stably fixing the battery cells 10 in the battery module 100. Further, the barrier 250 may guide the directions for the supports 260 to be bent, such that it is possible to easily design the positional relation of the supports 260 with members used in the battery module 100.

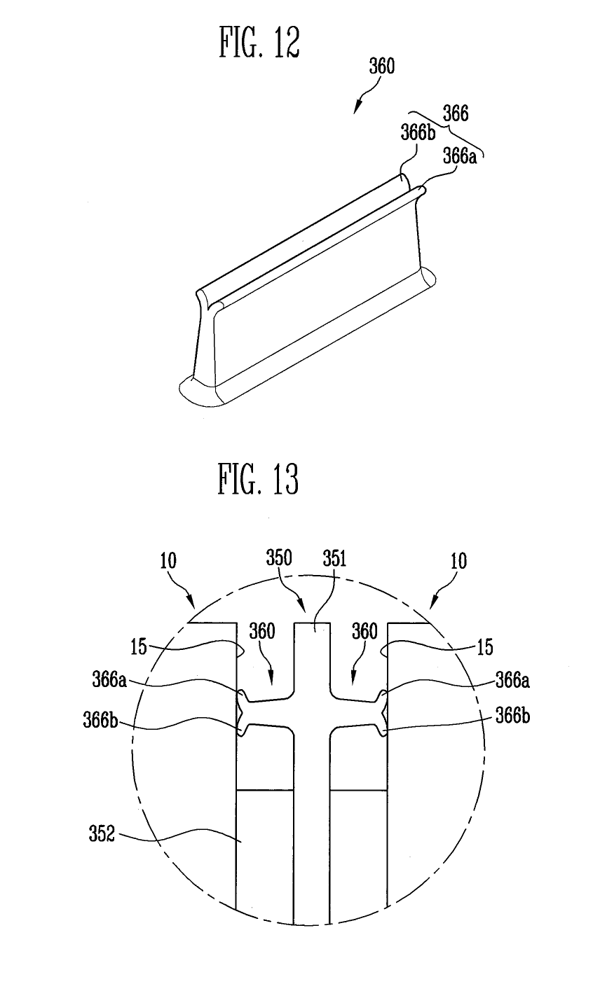

FIG. 11 is an enlarged perspective view of a support in a battery module according to another embodiment of the present invention. FIG. 12 is a perspective view showing an end of the support of FIG. 11. FIG. 13 is a schematic view showing a barrier having the support of FIG. 11 interposed between battery cells.

The barrier 350 according to this embodiment may include a base 351 facing the wide surface 15 of the battery cell 10, a spacer 352 protruding in parallel to a first direction toward the wide surface 15 of the battery cell 10 from the base 351, and a support 360 protruding toward the battery cell 10. An end 366 of the support 360 may be divided into a first portion 366a and a second portion 366b at the center thereof. The first and second portions 366a and 366b may contact the battery cell 10 and face each other while extending in opposite directions.

The support 360 may extend in a first direction (x-direction) from the base 351 to contact the wide surface 15 of the battery cell 10. In this embodiment, an area of a section of the support 360 may gradually decrease as it approaches the end 366 of the support 360. However, in this embodiment, the end 366 of the support 360 is divided into the first and second portions 366a and 366b, and, thus, the contact area of the support 360 with the battery cell 10 is increased, thereby stably fixing the battery cell 10.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned along a first direction;
at least one barrier between respective adjacent battery cells of the plurality of battery cells; and
a housing accommodating the plurality of battery cells and the barriers,
wherein each barrier between respective adjacent battery cells comprises a base parallel to a wide surface of the respective adjacent battery cells, at least one spacer protruding in a direction parallel to the first direction and extending toward the wide surface of a respective adjacent battery cell from the base, and at least one support extending further from the base than the at least one spacer.

2. The battery module of claim 1, wherein each battery cell of the plurality of battery cells comprises a battery case accommodating an electrode assembly, and the wide surface of each battery cell includes a face configured to face the electrode assembly, and an edge extending from a perimeter of the face toward sides of the wide surface of the battery cell.

3. The battery module of claim 2, wherein the edge surrounds the wide surface of the battery cell, the face is surrounded by the edge, the at least one spacer contacts the face, and the at least one support is configured to compress the edge.

4. The battery module of claim 1, wherein the base comprises a shape corresponding to the wide surface of the battery cells.

5. The battery module of claim 1, wherein the at least one spacer is at an inside of the base, and. the at least one support is adjacent to an end portion of the base.

6. The battery module of claim 1, wherein each barrier further comprises one or more flanges facing side surfaces of the respective adjacent battery cell from at least one side of each edge of the base.

7. The battery module of claim 6, wherein the one or more flanges comprise a pair of side flanges at each respective side portion of the base, a lower flange at a lower portion of the base, and an upper flange at an upper portion of the base.

8. The battery module of claim 7, wherein the side and/or lower flanges define one or more openings configured to act as a passageway for a heat exchange medium.

9. The battery module of claim 8, wherein the pair of side flanges face each other in a second direction perpendicular to the first direction, and the at least one support protrudes in the first direction and extends in the second direction.

10. The battery module of claim 9, wherein each of the side flanges defines a plurality of openings spaced apart from each other, and a bridge between adjacent openings of the plurality of openings, and wherein the openings in each of the side flanges face each other, and the at least one support is configured to correspond to the bridge.

11. The battery module of claim 10, wherein the openings in each of the side flanges are configured to provide a passageway for a heat exchange medium, and the at least one support is parallel to a direction of flow of the heat exchange medium.

12. The battery module of claim 1, wherein the at least one support comprises one or more first support tabs adjacent to an upper end portion of the base parallel to the upper end portion, and one or more second support tabs adjacent to a lower end portion of the base parallel to the lower end portion, and wherein the first and second support tabs are configured to correspond with each other.

13. The battery module of claim 12, wherein the at least one support further comprises third support tabs adjacent to each respective end portion of the base in a direction perpendicular with each respective end portion.

14. The battery module of claim 12, wherein the supports of the first support tab and the supports of the second support tab each comprise respective first surfaces extending in the first direction and facing each other, and wherein the first surfaces are parallel to each other.

15. The battery module of claim 14, wherein the supports of the first support tab and the supports of the second support tab each comprise respective second surfaces opposite to the first surfaces, and wherein the second surfaces are inclined toward the first direction.

16. The battery module of claim 1, wherein an end of the at least one support is divided into a first portion and a second portion through its center, and wherein the first and second portions are configured to contact the respective adjacent battery cell and to face each other while extending in opposite directions,

17. The battery module of claim 1, wherein the at least one support is coupled to the base with a rounded form.

18. The battery module of claim 1, wherein an end of the at least one support contacting the battery cell is rounded.

19. The battery module of claim 1, wherein a height of the at least one support is approximately 0.4 millimeters to approximately 2 millimeters greater than a height of the at least one spacer.
